(19) United States
(12) Patent Application Publication
(10) Pub. No.: US 2010/0303269 A1
(43) Pub. Date: Dec. 2, 2010

(54) FITTING PROCEDURE FOR HEARING DEVICES AND CORRESPONDING HEARING DEVICE

(75) Inventor: Herbert Baechler, Meilen (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/599,720

(22) PCT Filed: May 18, 2007
(86) PCT No.: PCT/EP2007/054816

§ 371 Date: Nov. 11, 2009

(51) Int. Cl. H04R 25/00

(52) U.S. Cl. 381/321

(57) ABSTRACT

The method for adjusting a hearing device to the hearing preferences of a user of said hearing device comprises the steps of
a) classifying a hearing loss of said user according to one of N pre-defined hearing loss classes, wherein N≧3;
b) obtaining, in dependence of said one hearing loss class, a gain model.

The hearing system according to the invention comprises
a sound generating unit for generating test sounds;
a user interface for receiving user input from a user of said hearing system;
a control unit operationally connected to said sound generating unit and to said user interface;
   wherein said control unit is adapted to classifying a hearing loss of said user—in dependence of said test sounds and said user input—according to one of N pre-defined hearing loss classes, wherein N≧3; and said control unit is adapted to obtaining—in dependence of said one hearing loss class—a gain model. A simplified hearing device fitting can be achieved.

### TECHNICAL FIELD

The invention relates to the field of hearing devices and in particular to the fitting of hearing devices, i.e., to adjusting a hearing device to the hearing preferences of a user of said hearing device. It relates to methods and apparatuses according to the opening clause of the claims.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

A hearing system comprises at least one hearing device. In case that a hearing system comprises at least one additional device, all devices of the hearing system are operationally connectable within the hearing system. Typically, said additional devices such as another hearing device, a remote control or a remote microphone, are meant to be worn or carried by said individual.

### BACKGROUND OF THE INVENTION

The most common way of fitting a hearing device, i.e., adjusting a hearing device to the preferences of a user of said hearing device, involves using a personal computer external to the hearing device for determining an audiogram of said user and calculating, on basis of the audiogram, a gain model to be used for this user, wherein a gain model represents the basic amplification characteristic in dependence of input level and frequency. This gain model is used at least as a first fit. Typically, later, some fine-tuning will take place, based upon said gain model, so as to further improve the gain model for improving the user's hearing sensation.

Said audiogram is unique for each user, and obtaining it involves in many cases a precise determination of the user's hearing loss for many frequencies. The whole procedure of determining the audiogram is carried out by a hearing device professional such as an audiologist.

The determination of the gain model is carried out using a specific algorithm, also referred to as fitting algorithm or fitting rationale, such as NAL-NL1, DSL-i/o and Phonak Digital.

From EP 1 617 705 A2, a hearing device is known, which can be fitted in-situ by the hearing device user. The hearing device plays test sounds to the user, which are known to the user from everyday life, and the user uses the hearing device's volume wheel for adjusting each test sound to comfortable audibility. Having made such adjustments for several test sounds, new parameter settings are calculated and used.

It is desirable to provide for an alternative way of fitting a hearing device.

### SUMMARY OF THE INVENTION

Therefore, one object of the invention is to create an alternative way of adjusting a hearing device to the hearing preferences of a user of said hearing device. In particular, a method for adjusting a hearing device to the hearing preferences of a user of said hearing device, and a corresponding hearing system, and a corresponding computer program product shall be provided.

Another object of the invention is to provide for a way of adjusting a hearing device to the hearing preferences of a user, which can easily be carried out by said user himself, in particular without or substantially without the help of a professional hearing device fitter.

Another object of the invention is to provide for a way of adjusting a hearing device to the hearing preferences of a user, which can be carried out solely with the hearing device or with the hearing system to which the hearing device belongs, without the need of additional means.

Another object of the invention is to provide for a way of adjusting a hearing device to the hearing preferences of a user, which is easily implementable.

Another object of the invention is to provide for a way of adjusting a hearing device to the hearing preferences of a user, which can be carried out even if no personal computer or similar means is available.

Another object of the invention is to provide for a way of adjusting a hearing device to the hearing preferences of a user, which can be carried out within a relatively short period of time.

Another object of the invention is to provide for a way of adjusting a hearing device to the hearing preferences of a user, which needs little storage space in the hearing device or hearing system.

Another object of the invention is to provide for a way of adjusting a hearing device to the hearing preferences of a user, which needs little processing power in the hearing device or hearing system.

Further objects emerge from the description and embodiments below.

At least one of these objects is at least partially achieved by apparatuses and methods according to the patent claims.

The method for adjusting a hearing device to the hearing preferences of a user of said hearing device comprises the steps of
a) classifying a hearing loss of said user according to one of N pre-defined hearing loss classes, in particular wherein N≧3, more particularly wherein N≧4;
b) obtaining, in dependence of said one hearing loss class, a gain model.

This allows to reduce the efforts and/or means required for determining a suitable gain model. For example, it is possible to render a precise determination of the individual hearing loss of the hearing device user superfluous.

Accordingly, instead of precisely determining the individual hearing loss of the hearing device user, it is only determined, to which of a number of pre-defined hearing loss classes the user's hearing loss belongs. The determination of said hearing loss class can be significantly easier than the precise determation of the individual hearing loss of the user or of the individual audiogram of the user. This can significantly reduce the time needed for the fitting, and can strongly simplify the fitting procedure.

In addition, the further processing, in particular the obtaining of a suitable gain model, can be simplified, when only one of a number of pre-defined hearing loss classes has to be dealt with, instead of dealing with an individual hearing loss, typically defined by a hearing loss curve, which has a very individual shape.

It is possible to provide for a fitting process that can be handled by the user, not requiring any specific knowledge.

Said hearing loss classes can, generally spoken, be defined in any way. Defining the hearing loss classes could be based on theoretical considerations, on medical knowledge or on statistical findings. The latter way is particularly promising, as it can take into account the hearing losses occurring in reality. It is to be noted that it turned out, that it can be useful to make statistical investigations separately for different countries and/or different etiologies of hearing losses, because this turns out to result in differently defined hearing loss classes.

It has been found that one or two hearing loss classes are not sufficient for achieving a satisfactory hearing sensation for most hearing device users. At least N=3, or better at least N=4 hearing loss classes should be provided. An optimum balance between sufficient differentiation for different users on the one side and complexity of the fitting and ease to use on the other side appears to occur for 5≦N≦9. Up to 12 or 14 hearing loss classes, complexity is still quite well manageable and provides for good differentiation, whereas above N=24, the fitting procedure tends to become too complex.

Said obtaining of a gain model as pointed out in step b) can, e.g. be or comprise a simple reading-out of data from a memory, e.g., reading-out of data from a look-up table. And/or, it may be or comprise a calculation, e.g., based on a fitting rationale.

In one embodiment, the method comprises the step of c) using said gain model in said hearing device.

This is the usual case, in which the gain model obtained in step b) is employed in the hearing device.

It can be advantageous to carry out step a) using said hearing device or using a device of a hearing system comprising said hearing device.

It can be advantageous to carry out step b) using said hearing device or using a device of a hearing system comprising said hearing device.

In one embodiment, steps a) and b) are carried out using said hearing device or using a device of a hearing system comprising said hearing device. In this case, the user's hearing device (or another device of a hearing system to which said hearing device belongs) is used for said classifying and for said obtaining of said gain model. This makes a fitting possible, which can be carried out solely by means of said hearing device or hearing system, without having to make use of other means such as an external personal computer.

It is also thinkable to carry out at least one step of steps a) and b) using external means, e.g., an external computer or another hearing device. For example, one might use a hearing device capable of providing a strong amplification for carrying out at least one of steps a) and b), and when it turns out, that the user only needs low or moderate amplification, a less powerful hearing device can be used—either with a gain model already obtained by means of the strong hearing device or for carrying out said steps a) and/or b) again and finishing the fitting.

Typically, said step a) comprises obtaining information about said hearing loss. More particularly, step a) typically comprises carrying out a hearing test.

Typically, the result of said classification, i.e. said one hearing loss class to which the user's hearing loss is assigned, depends on user input received during said obtaining of information about said hearing loss or during said hearing test.

Typically, the user's hearing loss is evaluated during said step a).

In one embodiment, said step a) comprises the step of playing at least one test sound to said user.

In a more particular embodiment, said step a) comprises the step of
d) playing a sequence of at least n different test sounds to said user, with n an integer; in particular wherein n≧N−1.

Preferably, at least N different test sounds are played to said user, i.e., n≧N. In particular, it is possible to play a sequence of N different test sounds to said user.

It is possible to repeat step d), for example upon the user's request.

In one embodiment, said at least one test sound is a signal, in particular a narrow-band signal. And in case of more than one test sound, said test sounds are differing in at least one of their output level and their frequency. E.g., sine tones or narrow band noises, e.g., with a band width of an octave or less, in particular of a third of an octave or less, can be used as test sounds.

It is possible to play a sequence of M×(N−1) or M×N test sounds to said user, in particular wherein each of M groups of N or N−1 test sounds have at least approximately the same frequency, and wherein each of N or N−1 groups of M test sounds have at least approximately the same output level. For small N, M=1 will mostly be sufficient, whereas for higher N such as above 6, M=2 or even M=3 or even higher may be appropriate.

Said playing of said test sounds can be useful in determining said hearing loss class.

In one embodiment, the frequency of said one or more test sounds is between 250 Hz and 4500 Hz. More preferably, said frequency is between 800 Hz and 2000 Hz. On the one hand, the mentioned frequency ranges are of great importance for speech intelligibility, and on the other hand, it has been found that, at least in case of hearing loss classes derived by statistical methods, said frequency ranges are specifically useful for distinguishing between the different hearing loss classes.

In one embodiment, said step a) comprises, after step d), the step of receiving a user input from said user upon said playing at least one test sound to said user.

In a more particular embodiment, said step a) comprises, after or during step d), the step of
e) receiving a user input from said user indicative of the number of said test sounds he perceived during step d).

This is a particularly simple way for obtaining information about said hearing loss class. Test sounds, at least partially of different output level, are played to the user, and all the user has to do is count, how many test sounds he perceived. Entering that number, e.g., by pressing a button correspondingly many times, will provide valuable information about said hearing loss class. In a simple case, this is already sufficient for unambiguously determining said hearing loss class.

In one embodiment, said step a) comprises the steps of
receiving a user input from said user during said playing said at least one test sound; and
using the point in time of said receiving said user input relative to said playing said at least one test sound for deriving information related to the user's hearing loss.

Said at least one test sound will typically provide for output levels, which are changing with time. The point in time, at which said user input is received can be related to said playing said at least one test sound, and, more specifically, to the output level of said at least one test sound at the point in time of said receiving said user input or at a point in time slightly before.

In particular, the user provides a user input as soon as he perceives a test sound or as soon as he no more perceives test sounds. In this case, several test sounds of different output levels and typically of the same frequency will be played to the user. Typically, said test sounds will be played as a sequence of test sounds in an order of increasing or decreasing output level. This can be done for M different frequencies, with M typically 1 or 2 or 3. M=5 or greater will usually not be necessary, but can, of course be implemented. Information about the user's hearing loss is readily obtained by relating the point in time of the user input to the point in time during the playing of the test sounds. Each of the test sounds can be presented to the user for a certain period of time, e.g., between 200 ms and 1000 ms, and the output level difference between consecutive test sounds will typically be chosen in the range of 2 dB to 6 dB. Of course, playing of test sounds and the receiving user input can be repeated, e.g., for corroborating the result.

It is also possible to play only one test sound or M test sounds of different frequency to said user, wherein the output level of the one test sound changes with time, e.g., the output level continuously increases or decreases with time, or increases or decreases in a stepwise manner with time. In such a case, the user could provide a user input, e.g., pressing a button of a user interface, as soon as he perceives said test sound or as soon as he no more perceives said test sound. Of course, the test sound playing and receiving of user input can be repeated, e.g., for corroborating the result. Information about the user's hearing loss is readily obtained by relating the point in time of the user input to the point in time of the playing of said test sound.

The embodiments in which the user provides a user input as soon as the or a test sound is or is no more perceived have the advantage that they are very easy to deal with for the user, since the user not even has to count. In particular for larger N, e.g., for N above 6 or 7, this might be preferable over the counting of perceived test sounds.

In one embodiment, said step b) comprises at least one of the steps of
f) accessing—based upon said one hearing loss class—data representative of said gain model stored in a storage unit;
g) accessing data stored in a storage unit and representative of a hearing loss curve typifying said one hearing loss class, and—based thereupon—calculating data representative of said gain model.

These are two ways allowing to obtain said gain model.

In step f), pre-calculated data representative of said gain model are available from a storage unit. Knowing said hearing loss class allows to access the gain model corresponding to said hearing loss class. This reduces the amount of calculations to be carried out during the fitting.

In step g), data representative of a hearing loss curve, which is the hearing loss curve typifying said hearing loss class, are available from a storage unit. Using this hearing loss curve, said gain model can be calculated, e.g., using a fitting rationale.

It shall be pointed out that gain models are typically represented in form of data representative of said gain model, such as parameters for a signal processor.

Therefore, the term “gain model” may occasionally be used, when, more strictly spoken, “data representative of a/the/said gain model” is meant.

In one embodiment, the method comprises the steps of
h) obtaining, upon a user input indicating a request for a change in loudness, a gain model belonging to a set of gain models each of which corresponds to a hearing loss curve belonging to a set of hearing loss curves comprising
   hearing loss curves, each typifying one of at least a portion of said hearing loss classes; and
   interpolations therebetween; and/or
   extrapolations therefrom;
      wherein the so-obtained gain model is different from a gain model currently used in said hearing device;
i) using said so-obtained gain model in said hearing device.

This embodiment allows for a special way of fine-tuning the hearing device and/or for changing the output level. For fine-tuning, a gain model belonging to a slightly different hearing loss than determined earlier, can be chosen. For output level changes, a change in output level, which depends on frequency and on input level, can be applied, as opposed to conventional volume controls, which simply change the output level, independent of frequency or input level. In opposition to conventional volume controls, a control for changing the output level in the above-described way could be considered a loudness control.

In fact, with respect to this embodiment, it does not necessarily have to be distinguished between fine-tuning the hearing device and making output level changes.

Said obtaining in step h) can be, e.g., selecting the respective gain model from a storage unit comprising pre-calculated gain models. In another embodiment, it may comprise calculating said gain model, e.g., using a fitting rationale or a simplified calculation, when needed and/or upon request.

In one embodiment, each hearing loss curve belonging to said set of hearing loss curves mentioned in step h) is of at least one of at least two hearing loss types, and said so-obtained gain model mentioned in steps h) and i) corresponds to a hearing loss curve of the same hearing loss type as the hearing loss curve corresponding to said gain model currently used in said hearing device.

It can be useful to assign said hearing loss curves belonging to said set of hearing loss curves mentioned in step h) to different hearing loss types; in particular if many hearing loss classes are provided (e.g., N>6) and/or when hearing loss curves typifying said hearing loss classes intersect or are of distinctly different shape. Typifying hearing loss curves of the same hearing loss type will usually not intersect and have a similar shape.

Upon requests as mentioned in step h), it will usually be useful to choose from hearing loss curves of the same hearing loss type.

Methods according to the invention can also be considered methods for operating a hearing device.

The hearing system according to the invention comprises
a sound generating unit for generating test sounds;
a user interface for receiving user input from a user of said hearing system;
a control unit operationally connected to said sound generating unit and to said user interface;
   wherein
said control unit is adapted to selecting—in dependence of said test sounds and said user input—one of N pre-defined hearing loss classes, wherein N≧3; and
said control unit is adapted to obtaining—in dependence of said one hearing loss class—a gain model.

Said control unit can be considered to be adapted to classifying a hearing loss of said user—in dependence of said test sounds and said user input—according to one of N pre-defined hearing loss classes, wherein N≧3.

In one embodiment, said control unit is adapted to installing said gain model for use in said hearing system.

In one embodiment, said control unit is adapted to controlling said sound generating unit such that, upon request, at least one test sound or a sequence of n different test sounds is played by said sound generating unit, in particular wherein n≧N−1.

In one embodiment, the hearing system comprises a storage unit comprising at least one of
data representative of said gain model;
data representative of a hearing loss curve typifying said one hearing loss class.

In one embodiment, the hearing system comprises a storage unit comprising at least one of
for a multitude of gain models: data representative of the respective gain model;
for a multitude of hearing loss curves: data representative of the respective hearing loss curve.

Typically, these are pre-calculated gain models and/or pre-calculated hearing loss curves, respectively.

In one embodiment, the hearing system comprises a calculating unit adapted to obtaining gain models in dependence of hearing loss curves.

In one embodiment, said control unit is adapted to obtaining, upon a user input indicating a request for a change in loudness, a gain model belonging to a set of gain models each of which corresponds to a hearing loss curve belonging to a set of hearing loss curves comprising
hearing loss curves, each typifying one of at least a portion of said hearing loss classes; and
interpolations therebetween; and/or
extrapolations therefrom;
   wherein the so-obtained gain model is different from a gain model currently used in said hearing device; and wherein said control unit is adapted to installing said so-obtained gain model for use in said hearing system.

The computer program product according to the invention comprises program code for causing a computer to perform the steps of
A) selecting one of N pre-defined hearing loss classes, wherein N≧3;
B) obtaining, in dependence of said one hearing loss class, a gain model.
   Step A) corresponds to classifying a hearing loss according to one of N pre-defined hearing loss classes, wherein N≧3.

In one embodiment, said computer is comprised in a hearing system.

It is pointed out, that most of the various embodiments described above can be combined with one another.

The advantages of hearing systems and computer program products correspond to the advantages of corresponding methods.

Further preferred embodiments and advantages emerge from the dependent claims and the figures.

### BRIEF DESCRIPTION OF THE DRAWINGS

Below, the invention is described in more detail by means of examples and the included drawings. The figures show schematically:

FIG. 1 a diagram of hearing loss curves typifying five hearing loss classes;

FIG. 2 a block diagram of a hearing system according to the invention;

FIG. 3 a block diagram of a method according to the invention;

FIG. 4 a diagram of hearing loss curves typifying seven hearing loss classes of two hearing loss types;

FIG. 5 a diagram of typifying hearing loss curves and further hearing loss curves;

FIG. 6 a diagram of a typifying hearing loss curve and further hearing loss curves;

FIG. 7 a diagram of gain curves illustrating a gain model;

FIG. 8 a diagram of gain curves illustrating a gain model;

FIG. 9 a diagram of gain curves illustrating a gain model;

FIG. 10 a diagrammatical illustration of playing test sounds.

The reference symbols used in the figures and their meaning are summarized in the list of reference symbols. The described embodiments are meant as examples and shall not confine the invention.

### DETAILED DESCRIPTION OF THE INVENTION

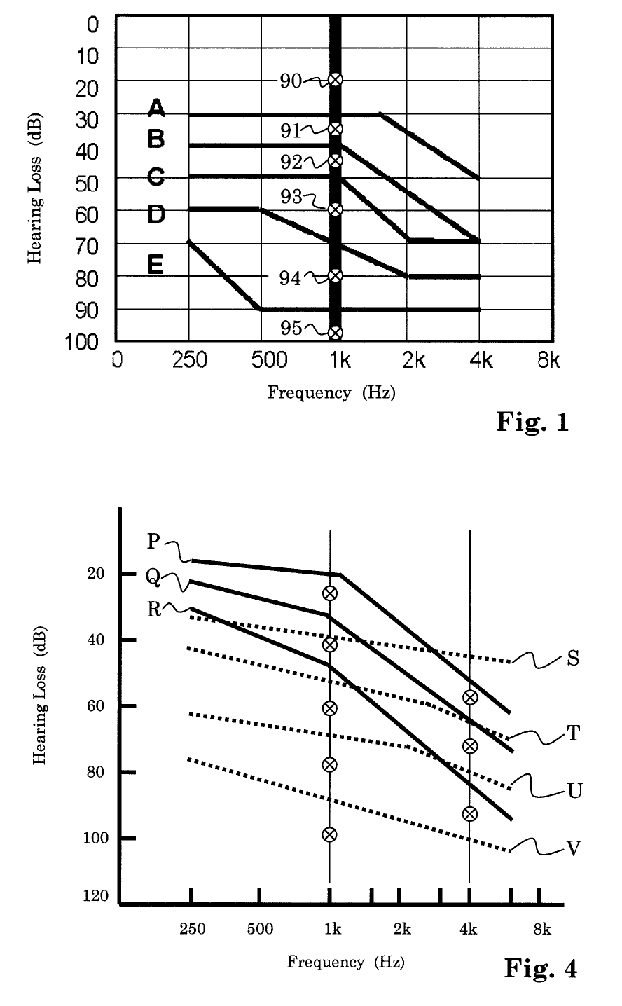

FIG. 1 shows a diagram of hearing loss curves labelled A, B, C, D and E, respectively, each typifying one of five hearing loss classes. Hearing loss curves represent hearing losses and are well-known and frequently used in the field of hearing device and, in particular, in the field of hearing-aid devices. Therefore, only an approximate description of what a hearing loss curve is—as useful within this application—is given: A hearing loss curve of a user describes the amplification (scaled in dB, also referred to as dB-HL) needed with respect to an average normal-hearing person for a sound of a given frequency to become just audible to said user.

The inventor has, using statistical methods, analyzed a great number of hearing loss curves of different individuals and formed groups of similar hearing loss curves, also referred to as hearing loss classes. An individual hearing loss can be assigned to at least one such hearing loss class. To each hearing loss class, there belongs one hearing loss curve, which is very typical for the hearing loss curves of the respective class. It can, e.g., be obtained by calculating a mean of all the hearing loss curves belonging to the respective class. This particular hearing loss curve is referred to as the hearing loss curve typifying said hearing loss class.

Said typifying hearing loss curves A to E shown in FIG. 1, belong to class A, class B, class C, class D and class E, respectively, wherein, e.g., class A can represent mild hearing loss, class B moderate hearing loss, class C moderately severe hearing loss, class D severe hearing loss, and class E profound hearing loss.

The idea now is, that for hearing device users having similar hearing losses, namely having hearing loss curves belonging to the same hearing loss class, a reasonable fitting result can be achieved by using a gain model chosen in dependence of said hearing loss class. For example, that gain model can be a gain model chosen in dependence of the typifying hearing loss curve of said hearing loss class.

The latter can be accomplished in any known way, e.g., by applying a fitting rationale such as such as NAL-NL1, DSL-i/o and Phonak Digital, to said typifying hearing loss curve.

A resulting gain model, e.g., for class A may look as the one as illustrated in FIG. 8. FIG. 8 shows gains in the hearing device in dB as a function of frequency, wherein three gain curves G1, G2, G3 are shown, each for a different input level. G1 is a gain curve for a high input level, G2 for a medium input level, and G3 for a low input level. The input level dependency results in a dynamics compression, which is usually required for achieving a good hearing sensation, as is well known in the art.

For assigning a hearing loss of a hearing device user to one of said hearing loss classes, very simple procedures can employed. For example, one or more test sounds can be played to the user. In particular, test sounds of substantially the same frequency, e.g., about 1 kHz as indicated by the thick line in FIG. 1, and of different output levels can be used, e.g., beeps. Possible test sounds are indicated in FIG. 1 by crossed circles labelled 90, 91, 92, 93, 94, 95. The output levels of the test sounds are also indicated in FIG. 1, scaled in dB-HL, wherein a conversion into more suitable or in particular into physical units such as dB-SPL (SPL=sound pessure level) can readily be accomplished.

It is very simple to produce such test sounds and, more importantly, it is very easy for a user to deal with such test sounds and to react upon them. For example, only the test sounds 91 to 94 could be played to the user, preferably in the order 91, 92, 93, 94. All the user has to do is count, how many test sounds he perceives. If no test sound is perceived, the user's hearing loss belongs to class E. If only one test sound (94) is perceived, it is class D. Perceiving two test sounds (93, 94) means class C. Perceiving three sounds (92, 93, 94) means class B. Perceiving all four test sounds (91, 92, 93, 94) means class A. It is very easy for a user to provide a user input indicative of the number of perceived test sounds. For example, the user can press a button the same number of times as the number of perceived test sounds of the test sound sequence 91, 92, 93, 94.

It can be advantageous to provide an additional test sound, namely test sound 95. This way, the user should in any case (except near-deafness) be able to perceive at least one test sound (95). This would provide a user with a clear signal that a test sound sequence has been played to him.

Nevertheless, e.g., in order to prevent a user with a mild hearing loss from being annoyed by a presentation of a too loud sound, it can be advisable not to present test sound 95, unless an at least moderate hearing loss of the user has been detected before, e.g., by the same procedure, but without test sound 95.

Adding another test sound, namely test sound 90, could provide the information that the tested individual does not actually need a hearing device, because if even that test sound 90 can be perceived, it indicates that there is no hearing loss that would require a treatment.

Accordingly, if N is the number of hearing loss classes, playing a series of n test sounds to the user can be sufficient for assigning the hearing loss class, with n=N−1 or preferably n=N, or n=N+1.

As is clear from the example of FIG. 1 with N=5, a particularly safe distinction between the hearing loss classes can be made around 1 kHz. A still very good distinction between the hearing loss classes is still possible at least between 500 Hz and 2 kHz.

Of course, it is also possible to use different frequencies for different test sounds.

It has to be noted that it is possible to use test sounds of pre-defined frequency and output level for the fitting according to the invention.

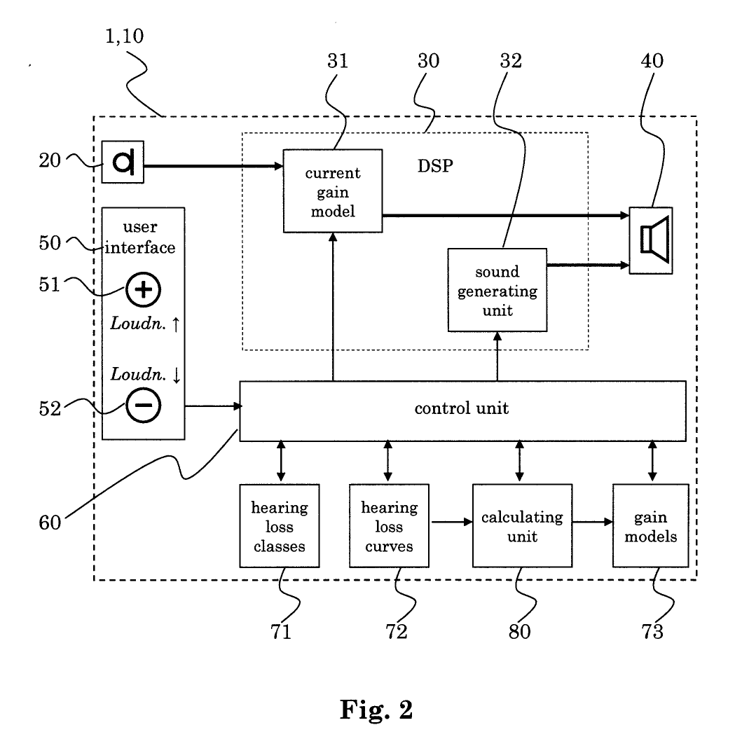

FIG. 2 shows a block diagram of a hearing system 1 according to the invention. The hearing system 1 can be identical with a hearing device 10 of the hearing system 1.

Hearing system 1 comprises an input unit 20, e.g., a microphone arrangement, a signal processor 30 and an output unit 40, e.g., a loudspeaker. It furthermore comprises a user interface 50, a control unit 60, storage units 71, 72, 73, and a calculating unit 80.

Signal processor 30 realizes a gain model 31 and comprises a sound generating unit 32, which could alternatively be embodied separate from the signal processor 30.

User interface 50 comprises two user controls 51,52, manipulable by the user, e.g., buttons.

During normal operation of the hearing system 1, input signals such as acoustic waves are received by input unit 20 and converted into audio signals (electrical signals, digital and/or analog, which represent sound), which are fed to signal processor 30. The audio signals are processed in signal processor 30, wherein the processing comprises realizing a currently selected gain model 31. A gain model is typically described within a hearing device by assigning values to a set of parameters. After the processing, the processed audio signals are fed to output unit 40 for obtaining signals to be perceived by the user, such as sound waves.

It is evident, that the described constituents of the hearing system 1 are merely functionally defined entities, which can as well be embodied in different compositions than shown in FIG. 2. E.g., control unit 60 could as well be realized as more than one control unit, or storage units 71, 72, 73 could as well be united to one storage unit.

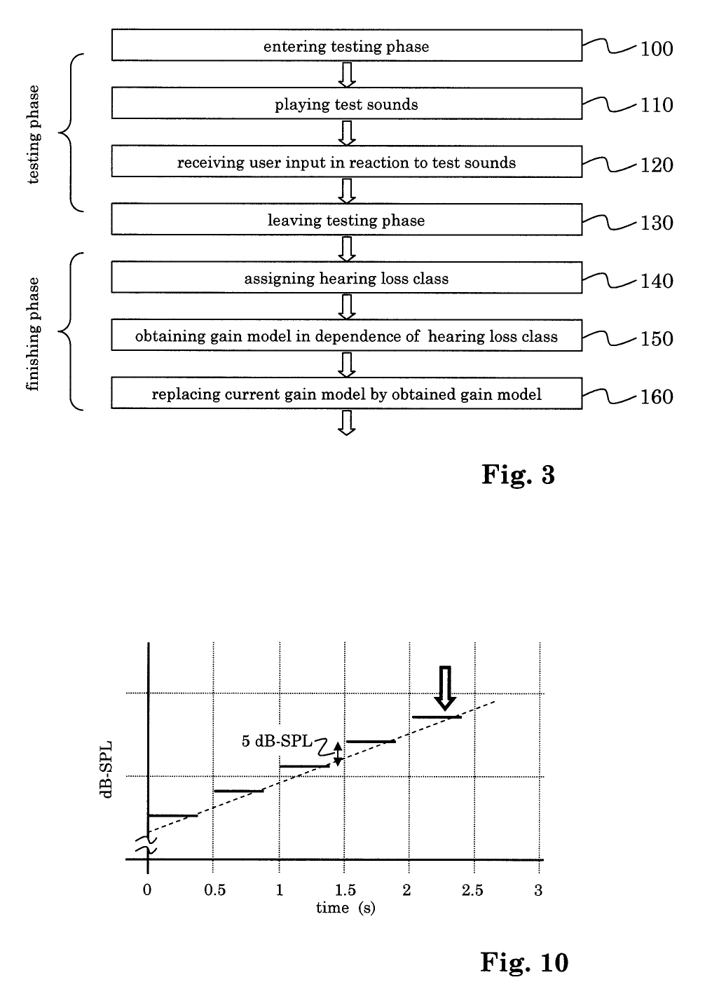

Finding and employing a gain model suitable for the user can be accomplished, e.g., in the way indicated in FIG. 3. FIG. 3 will be discussed together with the hearing system 1 of FIG. 2. FIG. 3 shows a block diagram of a method according to the invention. The steps 100 to 160 can be considered an embodiment of a fitting procedure.

In step 100, a testing phase is entered, e.g. by the user pressing both user controls 51,52 or by pressing and holding one or both user controls 51,52. Thereupon, control unit 60 will provoke the playing of test sounds by means of sound generating unit 32 (step 110) and output unit 40. Then, in step 120, the user has to react upon the playing of the test sounds, e.g., by pressing one of buttons 51,52, e.g., as many times as it corresponds to the number of test sounds the user perceived.

Steps 110 and 120 can be repeated to ensure consistent results. Automatically after step 120, or upon a signal of the user, e.g., by giving the same input as for entering the test phase (step 100), the test phase is finished (step 130).

The user input is evaluated, e.g., by control unit 60 and by referring to storage unit 71 comprising data related to the hearing loss classes, and the hearing loss class is assigned (step 140).

Then, in step 150, the gain model is obtained in dependence of the hearing loss class. This may be done by reading out data describing the gain model (e.g., parameters) from storage unit 73 and/or by obtaining the typifying hearing loss curve from storage unit 72 and obtaining therefrom the corresponding gain model, for example by means of calculating unit 80, e.g., using a fitting rationale.

Finally, in step 160, the currently-used gain model is replaced by the obtained gain model.

Whenever it seems adequate, the procedure may be repeated. E.g., during the so-called acclimatization time, in which the user gets used to perceiving “loud” acoustic signals again, or simply after some time passed and it appears that the currently-employed gain model is not quite appropriate anymore.

FIG. 4 shows a diagram of hearing loss curves P, Q, R, S, T, U, V typifying seven hearing loss classes of two hearing loss types. The kind of diagram of FIG. 4 is the same as the one of FIG. 1. Instead of N=5 in FIG. 1, there are N=7 classes in FIG. 4. These classes were also obtained via a statistical analysis of many hearing loss curves. As can be seen, the typifying hearing loss curves intersect considerably. Two types of hearing losses can be distinguished: classes P, Q, R represent hearing losses with a pronounced high-frequency loss, whereas classes S, T, U, V only show unsubstantial high-frequency losses.

Due to the strong intersecting of the typifying hearing loss curve, it is advisable or even necessary to use test sounds of different frequencies, for example some test sounds at about 1 kHz and some test sounds at about 4 kHz. The test sounds, more particularly their output level and their frequency, should be chosen such, that an unambiguous assignment of a hearing loss class can be made. The exemplary test sounds indicated in FIG. 4 (as crossed circles) should enable this.

The above-described fitting procedure, in which the user counts the number of perceived test sounds, is not the only fitting procedure that is very easy and can be carried out by the user himself. Further such fitting procedures will be explained in conjunction with FIG. 10.

FIG. 10 shows a diagrammatical illustration of a way of playing test sounds. The output level of test sounds, exemplarily scaled in dB-SPL, is shown in dependence of the time. One way of playing test sounds is illustrated by the bold lines: every 0.5 s, a test sound is played for 0.5 s or, as shown in FIG. 10, for a shorter period of time. The output volume of test sounds increases from test sound to test sound, e.g., by 5 dB-SPL. Typically, such a series of test sounds comprises test sounds of substantially the same frequency. The user is requested to provide a user input, e.g., by pressing a button, as soon as he perceives a test sound. The bold open arrow indicates the user input. The playing of test sounds (of that frequency) can be discontinued when said user input is received or slightly after that. From relating the point in time of the user input to the point in time of playing the test sounds, the user's approximate hearing loss at the frequency of the test sounds is readily deduced. In particular in case of two or more hearing loss types, e.g., as shown in FIG. 4, it will be advantageous to use at least two test sound frequencies, wherein the mode of playing these additional test sounds can be of the same kind as shown in FIG. 10. From this information about the user's hearing loss, the user's hearing loss class is readily obtained, e.g., in a way as described in the embodiments above.

The dashed line in FIG. 10 indicates the possibility to use only one test sound (per frequency), wherein that test sound changes its output level with time. Otherwise, the procedure is as described before, and relating the point in time of the user input to the playing of the test sound will readily provide information related to the user's hearing loss. Therefrom, the user's hearing loss class is readily obtained. Of course, a discountinuous/stepwise increase or decrease in output level can be used as well.

It is likely that a gain model found by one of the fitting procedures described above (in conjunction with FIGS. 1, 4 and 10, respectively) does not provide for a perfect fit for all users. Therefore, it is advantageous to provide for a possibility to fine-tune the hearing device. Such a fine-tuning may be accomplished in the manner explained below.

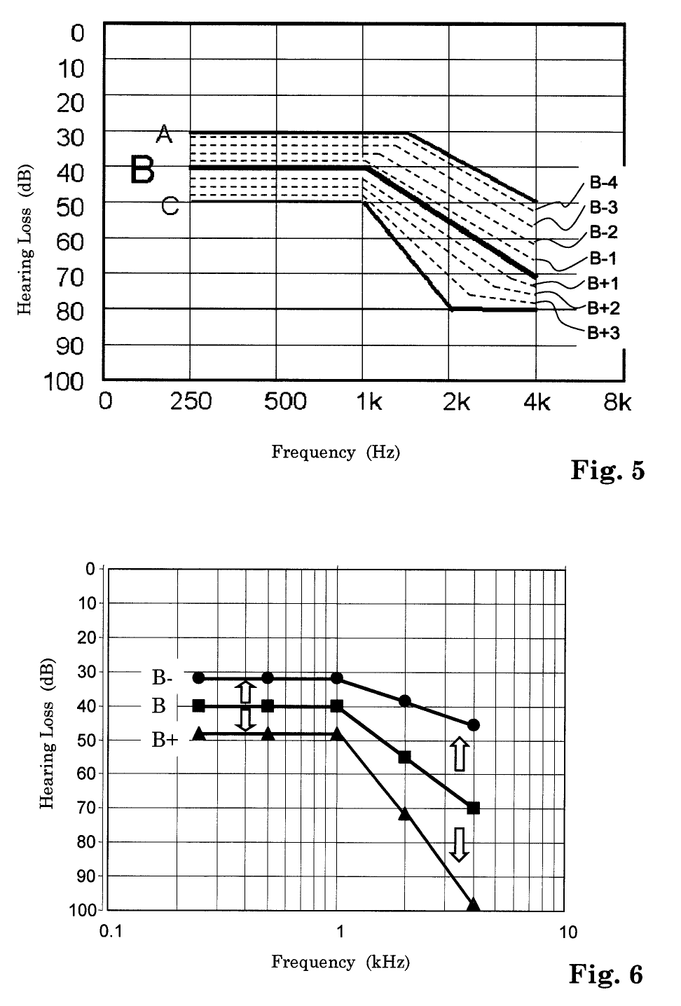

FIG. 5 shows a diagram of typifying hearing loss curves A, B, C and further hearing loss curves B−4, B−3, B−2, B−1, B+1, B+2, B+3. The latter hearing loss curves are obtained by interpolating between hearing loss curves A and B, and by interpolating between hearing loss curves B and C, respectively.

Assuming that the user's hearing loss was assigned to class B, the user can, for achieving a fine-tuning, switch from the gain model corresponding to the typifying hearing loss curve of class B to a gain model corresponding to the hearing loss curve B+1 or B−1, depending on whether the user perceives signals as too soft or as too loud. If this still appears insufficient, the user may switch from B+1 (or B−1) to B+2 (or B−2) or even further.

Such a switch or shift in gain models may be accomplished, e.g., by pressing button 51 (for moving towards stronger hearing loss/higher gain) and pressing button 51 (for moving towards weaker hearing loss/lower gain), respectively.

In fact, this changing or adapting gain models can as well be understood or used as an improved volume control, which can replace (or can be used in addition to) a conventional volume control. The advantage over a conventional volume control is, that it is possible to provide for frequency and input level dependent changes in output level.

Of course, it is possible and usually preferable to provide finer divisions between the typifying hearing loss curves than shown in FIG. 5.

Hearing loss curves such as B−4, B−3, B−2, B−1, B+1, B+2, B+3 can be provided in pre-calculated form, either already pre-stored before the fitting or after the determination of the hearing loss class, e.g., using calculating unit 80 (FIG. 2). Alternatively, it is possible to calculate each hearing loss curve upon request, e.g., when button 51 or 52 is pressed for fine-tuning (or for loudness control), e.g., using calculating unit 80 (FIG. 2).

Furthermore, the gain models corresponding to hearing loss curves such as B−4, B−3, B−2, B−1, B+1, B+2, B+3 can be provided in pre-calculated form, either already pre-stored before the fitting or after the determination of the hearing loss class, e.g., using calculating unit 80 (FIG. 2).

Alternatively, it is possible to calculate each gain model upon request, e.g., when button 51 or 52 is pressed for fine-tuning (or for loudness control), e.g., using calculating unit 80 (FIG. 2) and possibly based on the corresponding hearing loss curve.

FIG. 6 shows a diagram of a typifying hearing loss curve B and further hearing loss curves B−, B+. Curves B− and B+ are obtained by extrapolating from curve B, which renders a different result than shown in FIG. 5, at least for stronger hearing losses at higher frequencies (curve B+ in FIG. 6 vs. curve B+3 in FIG. 5).

The hearing loss curves shown in FIGS. 1, 4, 5 and 6 are rather simple functions, simplified with respect to immediate results of statistical investigations mentioned above. This has the advantage, that they are easily implementable and require only little computing power and/or storage space. It is, of course also possible to use more complicated curves, which possibly result in better fitting results, i.e., in a better hearing sensation for more users.

It is possible to obtain several hearing loss curves between B and B+ and between B and B− using only a very small number of numbers which parametrize the curves. This saves computing power and storage space in the hearing system.

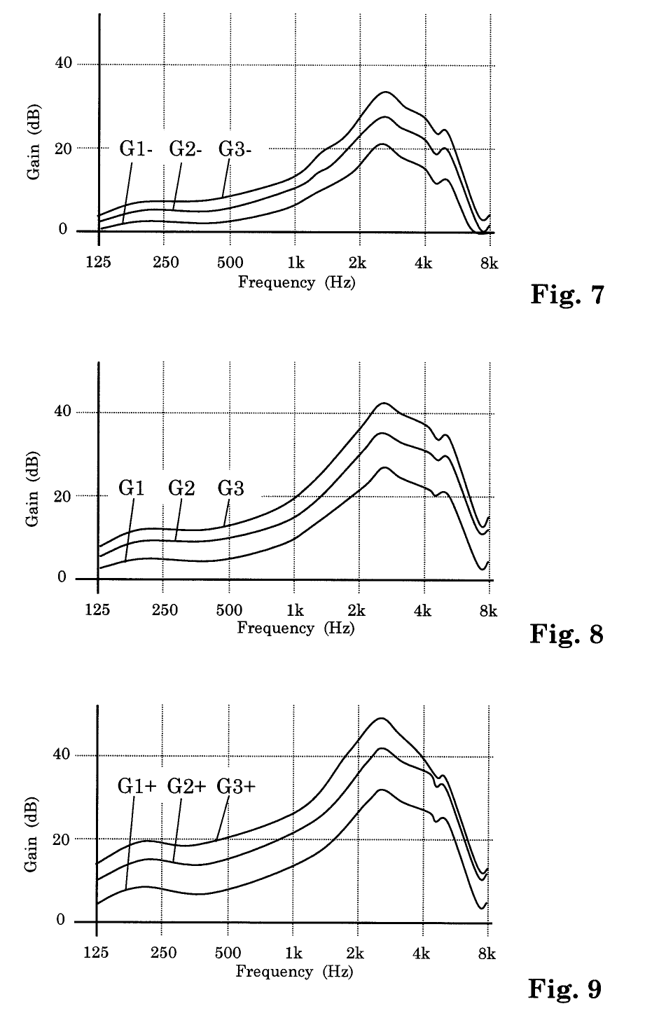

FIGS. 7, 8 and 9 each show a diagram of three gain curves illustrating a gain model. FIG. 8 has already been described above in conjunction with FIG. 1. Though quantitatively probably not quite correct, FIGS. 7, 8, 9 illustrate in a qualitatively correct manner gain models for hearing losses according to curves B'1, B, B+ of FIG. 6.

Coming back to FIG. 4, which illustrates two types of hearing losses, it is apparent that the calculation of hearing loss curves or gain models for fine-tuning or loudness control is not straight forward if interpolation shall be used. This is, because of the intersecting of the hearing loss curves P, Q, R, S, T, U, V. Therefore, in the case of hearing loss classes as shown in FIG. 4, the subdivision of the hearing loss classes in hearing loss types is helpful. Apparently, interpolation makes only sense between hearing loss curves of the same hearing loss type, i.e., between those drawn as solid lines (P,Q,R) and between those drawn as dahed lines (S,T,U,V).

The operating, in particular fitting, of a hearing system or hearing device in one of the ways described above can be carried out by the user alone, with a minimum of support or explanations required. It is possible to provide all necessary functionalities within a hearing system alone and even within a hearing device alone. As has been shown above, a still rather easy and straight-forward operation can be achieved with only two user controls. Operation with only one user control is, of course, also possible, e.g., using single and double clicks or distinguishing between different lengths in time of manipulating a user control. This is, nevertheless, a bit cumbersome, as the one user control has to have so many functions. Certainly, a remote control of the hearing system could comfortably be used during the procedure, maybe even one having a display providing instructions and/or helping information.

Fitting procedures according to the invention can be particularly useful in countries, in which complex fitting machines and adequate professional education is missing. Corresponding hearing devices could be sold over the counter with little or no additional explanations and be virtually self-fitted by a simple procedure as described above.

### LIST OF REFERENCE SYMBOLS

1 hearing system
10 hearing device, hearing-aid device
20 input unit, acoustic-electric converter unit, microphone
30 signal processor, digital signal processor
31 currently used gain model, parameter storage
32 sound generating unit
40 output unit, electric-acoustic converter unit, loudspeaker
50 user interface
51 user control, button
52 user control, button
60 control unit
71 storage unit
72 storage unit
73 storage unit
80 calculating unit
100 . . . 160 steps
A, B, C, D, E hearing loss curves, typifying hearing loss curves
B−, B+ hearing loss curves
B−4, B−3, B−2, B−3, B+1, B+2, B+3 hearing loss curves
G1, G1−, G1+ gain curves
G2, G2−, G2+ gain curves
G3, G3−, G3+ gain curves
P, Q, R, S, T, U, V hearing loss curves, typifying hearing loss curves

What is claimed is:

1. Method for adjusting a hearing device to the hearing preferences of a user of said hearing device, said method comprising the steps of
a) classifying a hearing loss of said user according to one of N pre-defined hearing loss classes, wherein N≧3;
b) obtaining, in dependence of said one hearing loss class, a gain model.

2. The method according to claim 1, wherein steps a) and b) are carried out using said hearing device or a hearing system comprising said hearing device.

3. The method according to claim 1, wherein 4≦N≦12.

4. The method according to claim 1, wherein said step a) comprises the step of playing at least one test sound to said user.

5. The method according to claim 4, wherein said at least one test sound is a narrow-band signal, and wherein in the case of more than one test sound, said test sounds are differing in at least one of their output level and their frequency.

6. The method according to claim 4, wherein the frequency of said at least one test sounds is between 250 Hz and 4500 Hz.

7. The method according to claim 4, wherein said step a) comprises the steps of
receiving a user input from said user during said playing said at least one test sound; and
using the point in time of said receiving said user input relative to said playing said at least one test sound for deriving information related to the user's hearing loss.

8. The method according to claim 4, wherein said step a) comprises the step of
d) playing a sequence of n different test sounds to said user, wherein n≧N−1.

9. The method according to claim 8, wherein said step a) comprises, after or during step d), the step of
e) receiving a user input from said user indicative of the number of said test sounds he perceived during step d).

10. The method according to claim 1, wherein said step b) comprises at least one of the steps of
f) accessing, based upon said one hearing loss class, data representative of said gain model stored in a storage unit;
g) accessing data stored in a storage unit and representative of a hearing loss curve typifying said one hearing loss class, and, based thereupon, calculating data representative of said gain model.

11. The method according to claim 1, comprising the steps of
h) obtaining, upon a user input indicating a request for a change in loudness, a gain model belonging to a set of gain models each of which corresponds to a hearing loss curve belonging to a set of hearing loss curves comprising
hearing loss curves, each typifying one of at least a portion of said hearing loss classes; and
interpolations therebetween; and/or
extrapolations therefrom;
wherein the so-obtained gain model is different from a gain model currently used in said hearing device;
i) using said so-obtained gain model in said hearing device.

12. The method according to claim 11, wherein each hearing loss curve belonging to said set of hearing loss curves is of at least one of at least two hearing loss types, and wherein said so-obtained gain model corresponds to a hearing loss curve of the same hearing loss type as the hearing loss curve corresponding to said gain model currently used in said hearing device.

13. Hearing system comprising
a sound generating unit for generating test sounds;
a user interface for receiving user input from a user of said hearing system;
a control unit operationally connected to said sound generating unit and to said user interface;
wherein
said control unit is adapted to selecting, in dependence of said test sounds and said user input, one of N pre-defined hearing loss classes, wherein N≧3; and
said control unit is adapted to obtaining, in dependence of said one hearing loss class, a gain model.

14. The hearing system according to claim 13, wherein said control unit is adapted to installing said gain model for use in said hearing system.

15. The hearing system according to claim 13, wherein said control unit is adapted to controlling said sound generating unit such that, upon request, a sequence of n different test sounds is played by said sound generating unit, wherein n≧N−1.

16. The hearing system according to claim 13, comprising a storage unit comprising at least one of
data representative of said gain model;
data representative of a hearing loss curve typifying said one hearing loss class.

17. The hearing system according to claim 13, comprising a storage unit comprising at least one of
for a multitude of gain models: data representative of the respective gain model;
for a multitude of hearing loss curves: data representative of the respective hearing loss curves.

18. The hearing system according to claim 13, comprising a calculating unit adapted to obtaining gain models in dependence of hearing loss curves.

19. The hearing system according to claim 13, wherein said control unit is adapted to obtaining, upon a user input indicating a request for a change in loudness, a gain model belonging to a set of gain models each of which corresponds to a hearing loss curve belonging to a set of hearing loss curves comprising
hearing loss curves, each typifying one of at least a portion of said hearing loss classes; and
interpolations therebetween; and/or
extrapolations therefrom;
wherein the so-obtained gain model is different from a gain model currently used in said hearing device; and wherein said control unit is adapted to installing said so-obtained gain model for use in said hearing system.

20. The hearing system according to claim 19, wherein each hearing loss curve belonging to said set of hearing loss curves is of at least one of at least two hearing loss types, and wherein said so-obtained gain model corresponds to a hearing loss curve of the same hearing loss type as the hearing loss curve corresponding to said gain model currently used in said hearing device.

21. Computer program product comprising program code for causing a computer to perform the steps of
A) selecting one of N pre-defined hearing loss classes, wherein N≧3;
B) obtaining, in dependence of said one hearing loss class, a gain model.

22. The computer program product according to claim 21, wherein said computer is comprised in a hearing system.
